(19) United States
(12) Patent Application Publication
(10) Pub. No.: US 2020/0117531 A1
(43) Pub. Date: Apr. 16, 2020

(54) ERROR SOURCE MODULE IDENTIFICATION AND REMEDIAL ACTION

(71) Applicant: Microsoft Technology Licensing, LLC, Redmond, WA (US)

(72) Inventors: Srinivasan R. SUDHARSANA, Redmond, WA (US); Ajay Y. MANSATA, Sammamish, WA (US); Srinivasa Rao KADIYALA, Bothell, WA (US); Nan LU, Bellevue, WA (US); Onkar BAKSHI, Bothell, WA (US); Kiran Babu JULAPALLI, Bellevue, WA (US); Sunil Manohar DATLA, Sammamish, WA (US); Tulika GUPTA, Hyderabad (IN)

(73) Assignee: Microsoft Technology Licensing, LLC, Redmond, WA (US)

(21) Appl. No.: 16/156,269

(22) Filed: Oct. 10, 2018

(51) Int. Cl. G06F 11/07; G06N 99/00

(52) U.S. Cl. CPC G06F 11/0793; G06F 11/0751; G06N 99/005; G06F 11/079; G06F 11/0772

(57) ABSTRACT

A server computing device is provided, including non-volatile memory and a processor. The processor may receive a plurality of telemetry signals from a plurality of modules executed on a plurality of computing devices. The plurality of modules may be arranged in a dependency hierarchy. The processor may further determine that the plurality of telemetry signals include a plurality of error signals indicating errors at one or more of the modules. Based on the plurality of error signals and a representation of the dependency hierarchy, the processor may further identify an error source module that, among the plurality of modules from which error signals are received, is highest in the dependency hierarchy. The processor may further select a remedial action based on the identification of the error source module. The processor may further output a remedial action notification including an indication of the error source module and/or the remedial action.

### BACKGROUND

Web services typically use multiple server-executed modules to deliver content and functionality of end users. Such modules may be dependent upon other modules such that when one module fails, other modules may fail as a result. According to existing systems and methods for offering web services, it may be difficult for a web service administrator to determine the source of the failure when the web service is implemented across a large number of devices. Since locating the source of an error may be difficult, functionality of the web service may experience outages that are time-consuming and resource-intensive to fix.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of the present disclosure, a server computing device is provided, including non-volatile memory and a processor configured to execute instructions stored in the non-volatile memory. The processor may execute instructions to receive a plurality of telemetry signals from a plurality of modules executed on a plurality of computing devices in one or more data centers. The plurality of modules may be arranged in a dependency hierarchy. The processor may further execute instructions to determine that the plurality of telemetry signals include a plurality of error signals indicating errors at one or more of the modules. Based on the plurality of error signals and a representation of the dependency hierarchy stored in the non-volatile memory, the processor may further execute instructions to identify an error source module that, among the plurality of modules from which error signals are received, is highest in the dependency hierarchy. The processor may further execute instructions to select a remedial action based on the identification of the error source module. The processor may further execute instructions to output a remedial action notification including an indication of the error source module and/or the remedial action.

### BRIEF DESCRIPTION OF THE DRAWINGS

FIG. 1 shows a schematic representation of an example server computing device, according to one embodiment of the present disclosure.

FIG. 2 shows an example dependency hierarchy, according to the embodiment of FIG. 1.

FIG. 3A shows an example of performing a diagnostic test, according to the embodiment of FIG. 1.

FIG. 3B shows an example of transferring a module from a first set of one or more computing devices to a second set of one or more computing devices, according to the embodiment of FIG. 1.

FIG. 4 shows a schematic representation of an example server computing device in which error history is stored in non-volatile memory, according to the embodiment of FIG. 1.

FIG. 5 shows an example training set for a machine learning algorithm, according to the embodiment of FIG. 1.

FIG. 6A shows a flowchart of an example method that may be performed at a server computing device.

FIGS. 6B and 6C show additional steps that may be performed in some embodiments when performing the method of FIG. 6A.

FIG. 7 shows a schematic view of an example computing environment in which the computer device of FIG. 1 may be enacted.

### DETAILED DESCRIPTION

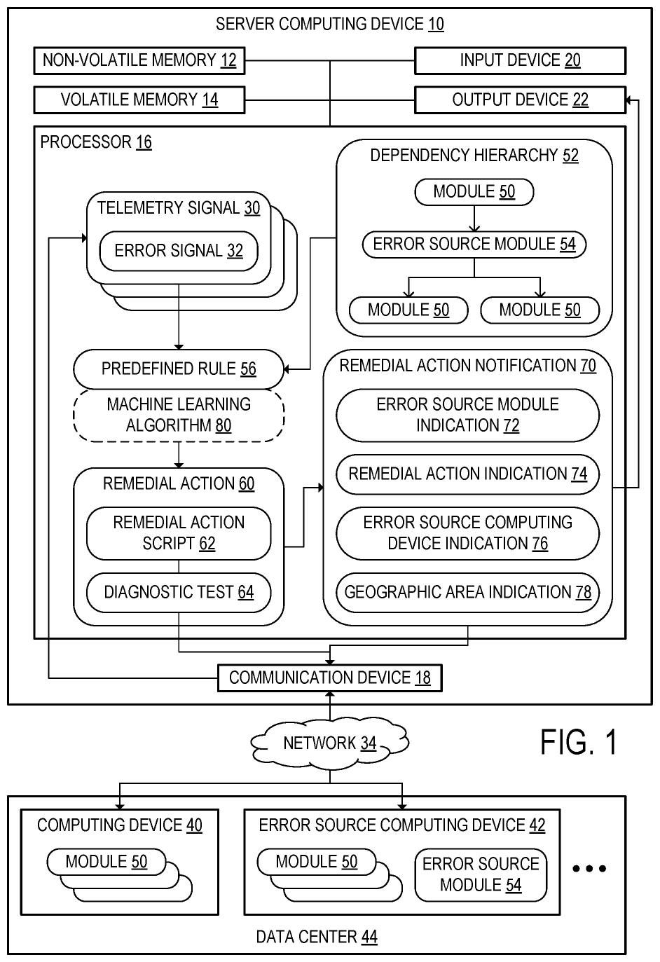

In order to address the problems discussed above, a server computing device 10 is provided, as shown in FIG. 1. The server computing device 10 of FIG. 1 may be configured for detection, notification, and remediation of errors that may occur when providing a web service to one or more end users. The server computing device 10 may include a processor 16 and non-volatile memory 12 operatively coupled to the processor 16. The processor 16 may be configured to execute instructions stored in the non-volatile memory 12. The server computing device 10 may further include volatile memory 14 operatively coupled to the non-volatile memory 12 and the processor 16. The server computing device 10 may further include one or more input devices 20 and/or one or more output devices 22. For example, the one or more input devices 20 may include one or more of a touchscreen, a keyboard, a trackpad, a mouse, a button, a microphone, a camera, an accelerometer, and/or one or more other input devices 20. The one or more output devices 22 may include one or more of a display, a speaker, a haptic feedback device, and/or one or more other output devices 22.

The server computing device 10 may further include one or more communication devices 18 configured to receive incoming data from and/or transmit outgoing data to a plurality of other computing devices 40. The server computing device 10 may be configured to communicate with the plurality of computing devices 40 via a network 34, e.g. a local area network or wide area network. The computing devices 40 may be one or more other server computing devices configured to provide a web service to one or more end users. Similarly to the server computing device 10, the computing devices 40 may each include non-volatile memory, volatile memory, one or more processors, one or more input devices, one or more output devices, and/or one or more communication devices. Each of the computing devices 40 may be configured to execute one or more modules 50 to provide all or part of the web service. Thus, the web service may be provided to one or more end users by the plurality of modules 50. For example, the plurality of modules 50 may include one or more application program interfaces (APIs).

In some embodiments, the server computing device 10 and/or the one or more computing devices 40 may be located in one or more data centers 44. The server computing device 10 and the plurality of computing devices 40 may, in some embodiments, be located at the same data center 44. In such embodiments, the server computing device 10 may provide on-premises error detection and remediation for the plurality of computing devices 40 that provide the web service. In other embodiments, the server computing device 10 may be located in a different data center 44 from one or more of the plurality of computing devices 40 and may offer remote error detection and remediation.

The processor 16 may be configured to execute instructions to receive a plurality of telemetry signals 30 from the plurality of modules 50 executed on the plurality of computing devices 40. The telemetry signals 30 may each include metadata associated with the execution of the modules 50 by the computing devices 40. For example, the telemetry signals 30 associated with a module 50 may indicate processor and/or volatile memory usage for that module 50. The plurality of telemetry signals 30 may be extracted from the plurality of modules 50 via a respective plurality of hooks included in the modules 50. The plurality of telemetry signals 30 may be received at the server computing device 10 via the one or more communication devices 18.

The plurality of modules 50 executed at the plurality of computing devices 40 may be arranged in a dependency hierarchy 52. A module 50 that is higher on the dependency hierarchy 52 may pass one or more outputs to a module 50 that is lower on the dependency hierarchy 52. In addition, inputs received from end users may be passed up the dependency hierarchy. Thus, the module 50 that is lower on the dependency hierarchy 52 may depend upon the module 50 that is higher on the dependency hierarchy 52 to function properly. Some modules 50 may depend upon a plurality of other modules 50. Additionally or alternatively, a module 50 may conditionally depend upon one or more other modules 50 such that input from the one or more other modules 50 is used only when one or more conditions are met. A representation of the dependency hierarchy 52 may be stored in the non-volatile memory 12 of the server computing device 10.

The processor 16 may be further configured to execute instructions to determine that the plurality of telemetry signals 30 include a plurality of error signals 32 indicating errors at one or more of the modules 50. In some embodiments, the telemetry signals 30 may include one or more error messages output at the computing devices 40 by the one or more modules 50 at which errors occur. In other embodiments, the processor 16 may execute instructions to determine that a module 50 has encountered an error even in the absence of an error message. For example, the processor 16 may determine that a module 50 has stopped running or is running more slowly than usual.

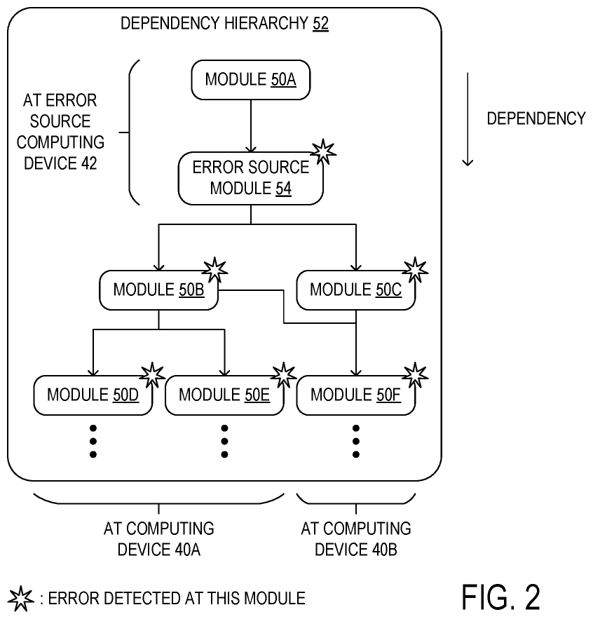

FIG. 2 shows an example of the propagation of an error through an example dependency hierarchy 52. In the example of FIG. 2, an error originates at an error source module 54. The error source module 54 depends upon a module 50A. The module 50A and the error source module 54 are both executed at an error source computing device 42. In addition, modules 50B and 50C depend upon the error source module 54. Further down the dependency hierarchy 52, modules 50D and 50E depend upon module 50B, and module 50F depends upon modules 50B and 50C. Modules 50B, 50D, and 50E are executed at a computing device 40A, and modules 50C and 50F are executed at computing device 40B. In the example of FIG. 2, the server computing device 10 would receive telemetry signals 30 including respective error signals 32 from each of the error source module 54 and the modules 50B, 50C, 50D, 50E, and 50F, but not from the module 50A.

In some embodiments, the representation of the dependency hierarchy 52 may be constructed at the server computing device 10. The dependency hierarchy 52 of the plurality of modules 50 may be determined, for example, in an audit mode of the server computing device 10. In the audit mode, the plurality of modules 50 may be executed using a plurality of test inputs. The plurality of test inputs may be inputs received during prior execution of the plurality of modules 50 at the plurality of computing devices 40. Thus, execution of the plurality of modules 50 at the plurality of computing devices 40 may be simulated at the server computing device 10 outside of a production environment. When the plurality of modules 50 are executed in audit mode, the plurality of modules 50 may output a plurality of respective audit-mode telemetry signals including one or more audit-mode error signals. Based on the one or more audit-mode error signals, the dependency hierarchy 52 may be heuristically determined. This determination of the dependency hierarchy 52 may be performed programmatically. Alternatively, the web service administrator may construct the representation of the dependency hierarchy 52 manually based on the one or more audit-mode error signals.

Returning to FIG. 1, the processor 16 may be further configured to execute instructions to identify an error source module 54 at which the error indicated in the plurality of error signals 32 originates. This identification may be made based on the plurality of error signals 32 and the representation of the dependency hierarchy 52 stored in the non-volatile memory 12 of the server computing device 10. The processor 16 may identify the error source module 54 by identifying the module 50 among the plurality of modules 50 from which error signals are received that is highest in the dependency hierarchy 52. If two or more modules 50 are tied for the highest position in the dependency hierarchy 52 among the plurality of modules 50 from which error signals 32 are received, the two or more modules 50 may all be identified as error source modules 54. In some embodiments, the processor 16 may be configured to execute instructions to determine, for each module 50 included in the dependency hierarchy 52, a respective estimated probability that that module is an error source module 54. Thus, the processor 16 may estimate a probability that the error source module 54 has been accurately identified.

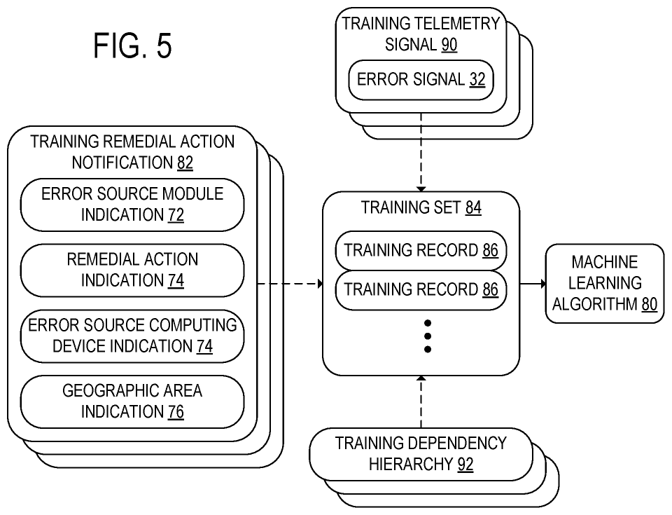

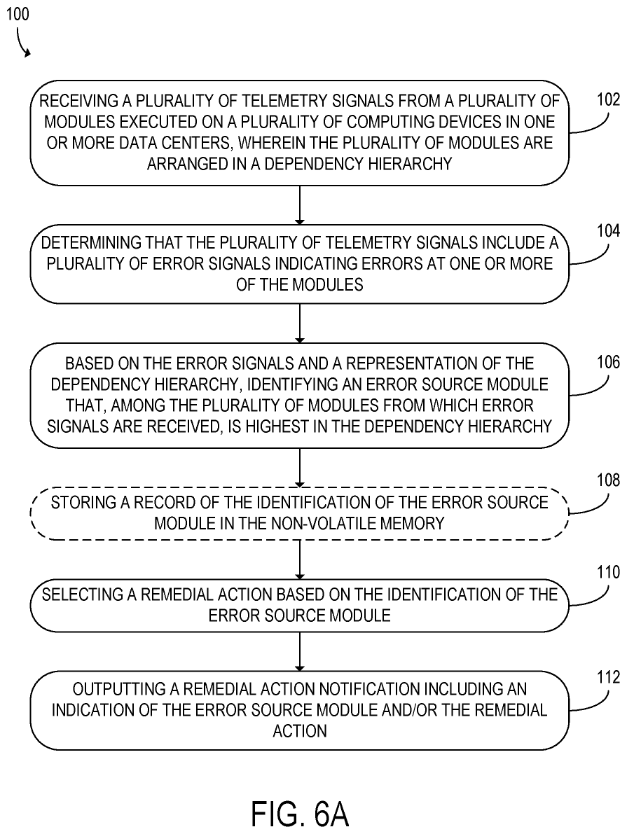

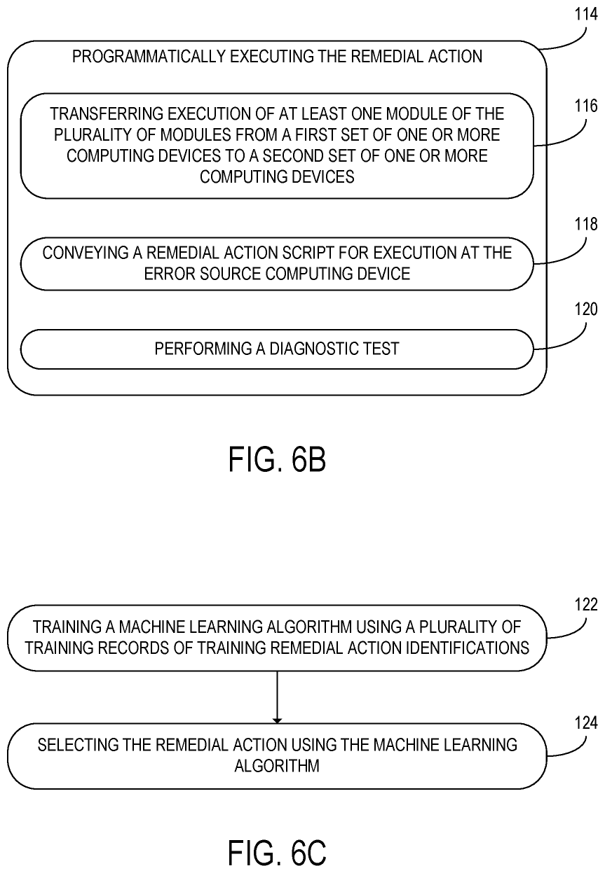

The processor 16 may be further configured to execute instructions to select a remedial action 60 based on the identification of the error source module 54. The remedial action 60 may be selected using a machine learning algorithm 80, as discussed below with reference to FIGS. 5 and 6C. Alternatively, the remedial action 60 may be selected based on one or more other predefined rules 56. For example, the processor 16 may execute instructions to select the remedial action 60 based at least in part on an estimated probability that the error source module 50 has been accurately identified. As another example, the processor 16 may execute instructions to select the remedial action 60 based at least in part on a level of the dependency hierarchy 52 at which the error source module 54 is located.

After a remedial action 60 has been selected, the processor 16 may be further configured to execute instructions to output a remedial action notification 70. In some embodiments, the remedial action notification 70 may be output at the one or more output devices 22. Additionally or alternatively, the remedial action notification 70 may be conveyed to another computing device via the one or more communication devices 18. The remedial action notification 70 may include an indication 72 of the error source module 54 and/or an indication 74 of the remedial action 60. The indication 74 of the remedial action may be a runbook including actions to be taken by an administrator of the web service. In some embodiments, the remedial action notification 70 may further include an indication 76 of at least one error source computing device 42 on which the error source module 54 is executed. In such embodiments, the remedial action notification 70 may further include an indication 78 of a geographic area in which the at least one error source computing device 42 is located. Thus, when the computing devices 40 are distributed over a plurality of data centers 44, the remedial action notification 70 may indicate a data center 44 or set of data centers 44 at which the error has occurred. This may allow the error source computing device 42 to be identified more quickly. The remedial action notification 70 may additionally or alternatively include other data related to the error.

In some embodiments, additionally or alternatively to outputting a remedial action notification 70, the processor 16 may be further configured to execute instructions to programmatically execute the remedial action 60. In such embodiments, the remedial action 60 may be executed without user intervention. In embodiments in which the processor 16 is configured to execute instructions to estimate a probability that the error source module 54 is correctly identified, the processor 16 may be configured to execute instructions to programmatically execute the remedial action 60 when the probability estimate exceeds a predetermined threshold. When the probability estimate does not exceed the predetermined threshold, the remedial action 60 may instead be taken by the web service administrator.

Programmatically executing the remedial action 60 may include conveying a remedial action script 62 for execution at the error source computing device 42. For example, the remedial action script 62 may interrupt and restart execution of the error source module 54. As another example, the remedial action script 62 may be configured to revert the error source module 54 to an earlier version of the error source module 54. Thus, if the processor 16 determines that the error is likely to have been caused by an update to the error source module 54, the remedial action script 62 may undo the update.

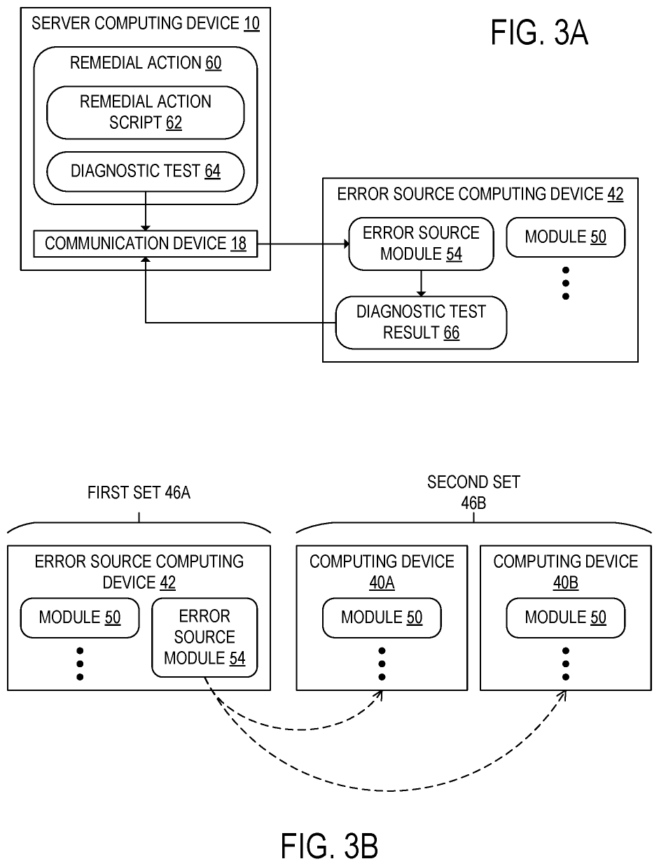

As shown in FIG. 3A, programmatically executing the remedial action 60 may include performing a diagnostic test 64. When the diagnostic test 64 is performed, the server computing device 10 may transmit the diagnostic test 64 as a script to be executed at the error source computing device 42. For example, as shown in FIG. 3, the diagnostic test 64 may be configured to input one or more predefined inputs into the error source module 54. The processor 16 may be further configured to execute instructions to receive a diagnostic test result 66 from the error source computing device 42. The diagnostic test result 66 may be analyzed, either programmatically or by the web service administrator, to obtain further information about the error. When further information about an error is programmatically determined by conducting a diagnostic test 64, the further information may be included in the remedial action notification 70.

As shown in FIG. 3B, programmatically executing the remedial action 60 may include, in some embodiments, transferring execution of at least one module 50 of the plurality of modules 50 from a first set 46A of one or more computing devices 40 to a second set 46B of one or more computing devices 40. In the example of FIG. 3B, the error source computing device 42, which is included in a first set 46A of one or more computing devices 40, ceases to execute the error source module 54. In addition, the computing device 40A and the computing device 40B, which are included in a second set 46B of one or more computing devices 40, begin to execute the error source module 54. Execution of an error source module 54 may be transferred in this way, for example, when the processor 16 determines that the error is likely to have been caused by a hardware failure at the error source computing device 42. Although, in the example of FIG. 3B, the error source module 54 is transferred, one or more other modules 50 may be additionally or alternatively transferred in other embodiments, for example, to balance processor and/or memory usage among the plurality of computing devices 40.

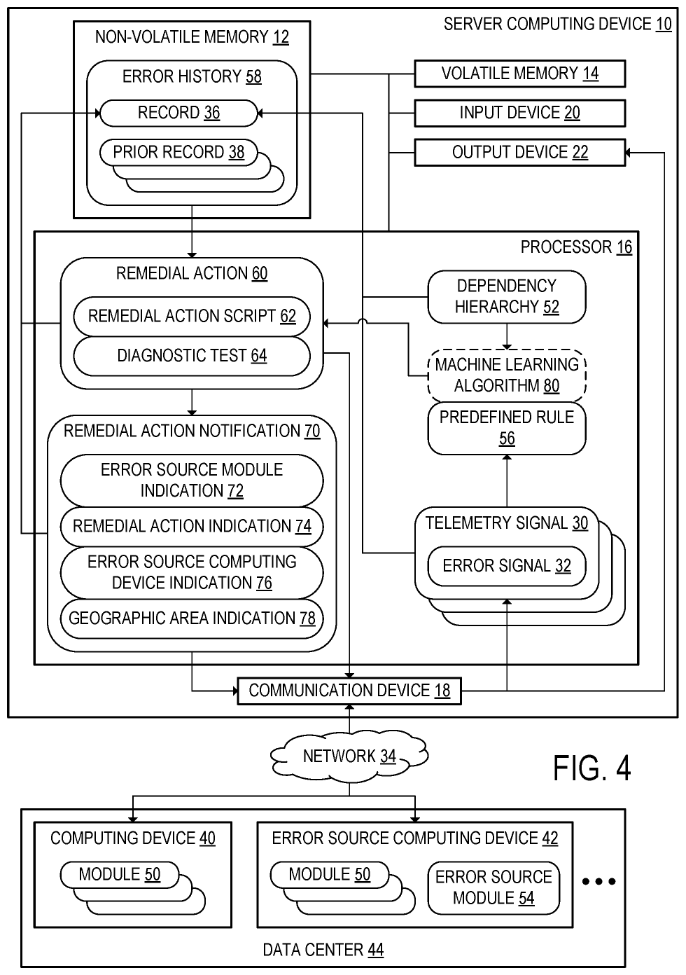

As shown in FIG. 4, when the error source module 54 is identified, the processor 16 may be further configured to execute instructions to store a record 36 of the identification of the error source module 54 in the non-volatile memory 12. In embodiments in which a remedial action notification 70 is conveyed, the record 36 may include the indication 72 of the error source module 54 that is included in the remedial action notification 70. The record 36 may further include an indication 74 of the remedial action 60, and indication 76 of the error source computing device 42, an indication 78 of the geographic area in which the error source computing device 42 is located, and/or any other information included in the remedial action notification 70. In some embodiments, the record 36 may include the telemetry signal 30 including the error signal 32 with which the remedial action notification 70 is associated and may additionally or alternatively include the dependency hierarchy 52 that includes the error source module 54. The non-volatile memory 12 may store error history 58 including the record 36 and optionally including one or more prior records 38. Similarly to the record 36, each of the prior records 38 may include any of the information included in respective prior remedial action notifications. The one or more prior records 38 may additionally or alternatively include other information.

In embodiments, in which error history 58 is stored in the non-volatile memory 12, the remedial action 60 may be selected based at least in part on one or more prior records 38 of one or more respective identifications of prior error source modules 54. For example, if the one or more prior records 38 indicate that the error source computing device 42 has repeatedly experienced hardware failures, the remedial action notification 70 may indicate for the error source computing device 42 to be removed from service for repair or replacement. As another example, if the error history 58 indicates that the error source module 54 is a module in which an error has never previously occurred, the processor 16 may execute instructions to send a remedial error notification 70 to the web service administrator rather than attempting to fix the error programmatically without human intervention.

As discussed above, the remedial action 60 may be selected using a machine learning algorithm 80 in some embodiments. Training of the machine learning algorithm 80 is shown with reference to FIG. 5. The machine learning algorithm 80 may be trained using a plurality of training records 86 of training remedial action identifications. In some embodiments, the training set 84 may include a plurality of training remedial action notifications 82, each of which may include any of the types of indication discussed above with reference to FIGS. 1 and 4. Additionally or alternatively, the machine learning algorithm 80 may be trained using a plurality of training telemetry signals 90 and/or a plurality of training dependency hierarchies 92.

The machine learning algorithm 80 may be trained via supervised or unsupervised learning. In embodiments in which supervised learning is used, a user may provide feedback to the machine learning algorithm 80 indicating whether a remedial action 60 output by the machine learning algorithm 80 is suitable given the training telemetry signal 90 and/or training dependency hierarchy 92 associated with that output. When unsupervised learning is used, the machine learning algorithm 80 may detect relationships between the training telemetry signals 90 and the training dependency hierarchies 92 as inputs and the training remedial action notifications 82 as outputs without user feedback.

In some embodiments, the training remedial action notifications 82, the training telemetry signals 90, the training dependency hierarchies 92, and/or other training records 86 included in the training set 84 may be taken from the error history 58. The machine learning algorithm 80 in such embodiments may be updated based on new data that is added to the error history 58 during operation of the server computing device 10. In other embodiments, the training records 86 included in the training set 84 may have been collected at another computing device.

Example use case scenarios for the server computing device 10 of FIG. 1 are provided below. In one example, a globally distributed front-end service calls a middle-tier API and does not receive a response. When the front-end service does not receive a response from the middle-tier API, the telemetry signals 30 sent to the server computing device 10 from the front-end API include error signals 32. The error signals 32 may, for example, indicate that the middle-tier API is non-functional in a particular geographic area. Thus, a remedial action notification 70 including an indication 78 of the geographic region may be sent to a web service administrator. The remedial action notification 70 may further include a runbook indicating a process by which the web service administrator may address the malfunction. For example, the web service administrator may redirect middle-tier API traffic in the indicated geographic region to a replica data layer in a different geographic region. The remedial action 60 made in response to the error may be saved automatically or by the web service administrator so that if the error occurs again, a similar remedial action 60 may be taken.

In another example, the processor 16 may receive telemetry signals 30 indicating that ongoing distribution of an update to a globally distributed API is causing the globally distributed API to fail to respond to a dependent API below the globally distributed API in the dependency hierarchy 52. Based on the determination that the update is causing the outage, the processor 16 may execute instructions to programmatically roll back the update and revert the globally distributed API to an earlier version. Additionally or alternatively, the processor 16 may execute instructions to transmit a remedial action notification 70 to the web service administrator. In embodiments in which the update is not rolled back programmatically, the update may be rolled back in response to input received from the web service administrator.

A flowchart of an example method 100 that may be performed at a server computing device is shown in FIG. 6A. The server computing device may be the server computing device 10 of FIG. 1 or may alternatively be some other server computing device. The method 100 may include, at step 102, receiving a plurality of telemetry signals from a plurality of modules executed on a plurality of computing devices in one or more data centers. The plurality of computing devices may be a plurality of other server computing devices configured to provide a web service. The telemetry signals may each include metadata related to the execution of the respective modules from which they are received, and/or other data related to the functioning of the plurality of computing devices. The plurality of modules may be arranged in a dependency hierarchy, a representation of which may be stored at the server computing device.

At step 104, the method 100 may further include determining that the plurality of telemetry signals include a plurality of error signals indicating errors at one or more of the modules. The plurality of error signals may be explicitly indicated in the plurality of telemetry signals and/or inferred based on the content of the telemetry signals. At step 106, the method 100 may further include identifying an error source module based on the error signals and the representation of the dependency hierarchy. The error source module may be a module that, among the plurality of modules from which error signals are received, is highest in the dependency hierarchy. If multiple modules from which error signals are received are tied for the highest position in the dependency hierarchy, each of those modules may be identified as an error source module.

In some embodiments, at step 108, the method 100 may further include storing a record of the identification of the error source module in non-volatile memory of the server computing device. In such embodiments, storing the record of the identification of the error source module may include storing telemetry signals including the error signals used to determine the error source module. The dependency hierarchy in which the error source module is included may also be stored.

At step 110, the method 100 may further include selecting a remedial action based on the identification of the error source module. In embodiments in which records of identifications of error source modules are stored in non-volatile memory, the remedial action may be selected based at least in part on one or more prior records of one or more respective identifications of prior error source modules.

At step 112, the method 100 may further include outputting a remedial action notification including an indication of the error source module and/or the remedial action. In some embodiments, the remedial action notification may further include an indication of at least one error source computing device on which the error source module is executed. In such embodiments, the remedial action notification may further indicate a geographic area in which the at least one error source computing device is located.

FIGS. 6B and 6C show additional steps that may optionally be performed as part of the method 100 in some embodiments. At step 114, shown in FIG. 6B, the method 100 may further include programmatically executing the remedial action. In such embodiments, programmatically executing the remedial action may include, at step 116, transferring execution of at least one module of the plurality of modules from a first set of one or more computing devices to a second set of one or more computing devices. Additionally or alternatively, step 114 may include conveying a remedial action script for execution at the error source computing device. Additionally or alternatively, step 114 may include performing a diagnostic test at the error source computing device and/or one or more other computing devices.

In some embodiments, as shown in FIG. 6C, a machine learning algorithm may be used when performing the method 100. At step 122, the method 100 may further include training a machine learning algorithm using a plurality of training records of training remedial action identifications. In addition, a plurality of training telemetry signals and/or training dependency hierarchies may be included in the training set used to train the machine learning algorithm. In embodiments in which step 108 is performed, the machine learning algorithm may be updated based on one or more records of identified error sources. In such embodiments, the machine learning algorithm may also be updated based on records of one or more telemetry signals and/or dependency hierarchies associated with the one or more error source identifications. At step 124, the method 100 may further include selecting the remedial action using the machine learning algorithm.

The systems and methods described above may address the deficiencies of existing web services regarding error source identification and correction. Using the systems and methods described above, sources of errors in the execution of the plurality of modules may be identified more quickly than they would be identified using existing methods. In addition, the systems and methods described above may allow errors that would otherwise require web service administrator intervention to be corrected programmatically instead. Thus, the systems and methods described above may allow for reduced web service downtime and may reduce the amount of work required of web service administrators, thereby increase system operating efficiency.

In some embodiments, the methods and processes described herein may be tied to a computing system of one or more computing devices. In particular, such methods and processes may be implemented as a computer-application program or service, an application-programming interface (API), a library, and/or other computer-program product.

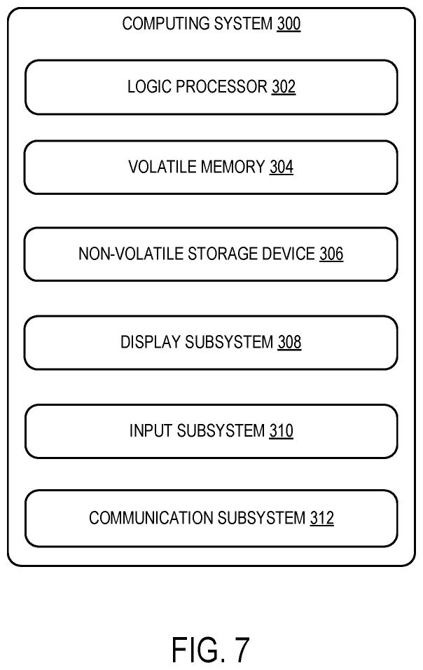

FIG. 7 schematically shows a non-limiting embodiment of a computing system 300 that can enact one or more of the methods and processes described above. Computing system 300 is shown in simplified form. Computing system 300 may embody the server computing device 10 described above and illustrated in FIG. 1. Computing system 300 may take the form of one or more personal computers, server computers, tablet computers, home-entertainment computers, network computing devices, gaming devices, mobile computing devices, mobile communication devices (e.g., smartphone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 7.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built-in. Non-volatile storage device 306 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FP GAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

According to one aspect of the present disclosure, a server computing device is provided, including non-volatile memory and a processor. The processor may be configured to execute instructions stored in the non-volatile memory to receive a plurality of telemetry signals from a plurality of modules executed on a plurality of computing devices in one or more data centers. The plurality of modules may be arranged in a dependency hierarchy. The processor may be further configured to execute instructions stored in the non-volatile memory to determine that the plurality of telemetry signals include a plurality of error signals indicating errors at one or more of the modules. The processor may be further configured to execute instructions stored in the non-volatile memory to identify, based on the plurality of error signals and a representation of the dependency hierarchy stored in the non-volatile memory, an error source module that, among the plurality of modules from which error signals are received, is highest in the dependency hierarchy. The processor may be further configured to execute instructions stored in the non-volatile memory to select a remedial action based on the identification of the error source module. The processor may be further configured to execute instructions stored in the non-volatile memory to output a remedial action notification including an indication of the error source module and/or the remedial action.

According to this aspect, the remedial action notification may further include an indication of at least one error source computing device on which the error source module is executed. The remedial action notification may indicate a geographic area in which the at least one error source computing device is located.

According to this aspect, the processor may be further configured to execute instructions stored in the non-volatile memory to programmatically execute the remedial action. Programmatically executing the remedial action may include transferring execution of at least one module of the plurality of modules from a first set of one or more computing devices to a second set of one or more computing devices. Programmatically executing the remedial action may include conveying a remedial action script for execution at the error source computing device. The remedial action script may be configured to revert the error source module to an earlier version of the error source module. Programmatically executing the remedial action may include performing a diagnostic test.

According to this aspect, the processor may be further configured to execute instructions stored in the non-volatile memory to store a record of the identification of the error source module in the non-volatile memory. The remedial action may be selected based at least in part on one or more prior records of one or more respective identifications of prior error source modules.

According to this aspect, the remedial action may be selected using a machine learning algorithm trained using a plurality of training records of training remedial action identifications.

According to another aspect of the present disclosure, a method performed at a server computing device is provided. The method may include receiving a plurality of telemetry signals from a plurality of modules executed on a plurality of computing devices in one or more data centers. The plurality of modules may be arranged in a dependency hierarchy. The method may further include determining that the plurality of telemetry signals include a plurality of error signals indicating errors at one or more of the modules. The method may further include, based on the error signals and a representation of the dependency hierarchy, identifying an error source module that, among the plurality of modules from which error signals are received, is highest in the dependency hierarchy. The method may further include selecting a remedial action based on the identification of the error source module. The method may further include outputting a remedial action notification including an indication of the error source module and/or the remedial action.

According to this aspect, the remedial action notification may include an indication of at least one error source computing device on which the error source module is executed.

According to this aspect, the method may further include programmatically executing the remedial action. Programmatically executing the remedial action may include transferring execution of at least one module of the plurality of modules from a first set of one or more computing devices to a second set of one or more computing devices. Programmatically executing the remedial action may include conveying a remedial action script for execution at the error source computing device.

According to this aspect, the method may further include storing a record of the identification of the error source module in non-volatile memory. The remedial action may be selected based at least in part on one or more prior records of one or more respective identifications of prior error source modules.

According to this aspect, the method may further include training a machine learning algorithm using a plurality of training records of training remedial action identifications. The method may further include selecting the remedial action using the machine learning algorithm.

According to another aspect of the present disclosure, a server computing device is provided, including non-volatile memory and a processor. The processor may be configured to execute instructions stored in the non-volatile memory to receive a plurality of telemetry signals from a plurality of modules executed on a plurality of computing devices in one or more data centers. The plurality of modules may be arranged in a dependency hierarchy. The processor may be further configured to execute instructions stored in the non-volatile memory to determine that the plurality of telemetry signals include a plurality of error signals indicating errors at one or more of the modules. The processor may be further configured to execute instructions stored in the non-volatile memory to identify, based on the plurality of error signals and a representation of the dependency hierarchy stored in the non-volatile memory, an error source module that, among the plurality of modules from which error signals are received, is highest in the dependency hierarchy. The processor may be further configured to execute instructions stored in the non-volatile memory to select a remedial action based on the identification of the error source module. The processor may be further configured to execute instructions stored in the non-volatile memory to programmatically execute the remedial action.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A server computing device comprising:
non-volatile memory; and
a processor configured to execute instructions stored in the non-volatile memory to:
receive a plurality of telemetry signals from a plurality of modules executed on a plurality of computing devices in one or more data centers, wherein the plurality of modules are arranged in a dependency hierarchy;
determine that the plurality of telemetry signals include a plurality of error signals indicating errors at one or more of the modules;
based on the plurality of error signals and a representation of the dependency hierarchy stored in the non-volatile memory, identify an error source module that, among the plurality of modules from which error signals are received, is highest in the dependency hierarchy;
select a remedial action based on the identification of the error source module; and
output a remedial action notification including an indication of the error source module and/or the remedial action.

2. The server computing device of claim 1, wherein the remedial action notification further includes an indication of at least one error source computing device on which the error source module is executed.

3. The server computing device of claim 2, wherein the remedial action notification indicates a geographic area in which the at least one error source computing device is located.

4. The server computing device of claim 1, wherein the processor is further configured to execute instructions stored in the non-volatile memory to programmatically execute the remedial action.

5. The server computing device of claim 4, wherein programmatically executing the remedial action includes transferring execution of at least one module of the plurality of modules from a first set of one or more computing devices to a second set of one or more computing devices.

6. The server computing device of claim 4, wherein programmatically executing the remedial action includes conveying a remedial action script for execution at the error source computing device.

7. The server computing device of claim 6, wherein the remedial action script is configured to revert the error source module to an earlier version of the error source module.

8. The server computing device of claim 4, wherein programmatically executing the remedial action includes performing a diagnostic test.

9. The server computing device of claim 1, wherein the processor is further configured to execute instructions stored in the non-volatile memory to store a record of the identification of the error source module in the non-volatile memory.

10. The server computing device of claim 9, wherein the remedial action is selected based at least in part on one or more prior records of one or more respective identifications of prior error source modules.

11. The server computing device of claim 1, wherein the remedial action is selected using a machine learning algorithm trained using a plurality of training records of training remedial action identifications.

12. A method performed at a server computing device, the method comprising:
receiving a plurality of telemetry signals from a plurality of modules executed on a plurality of computing devices in one or more data centers, wherein the plurality of modules are arranged in a dependency hierarchy;
determining that the plurality of telemetry signals include a plurality of error signals indicating errors at one or more of the modules;
based on the error signals and a representation of the dependency hierarchy, identifying an error source module that, among the plurality of modules from which error signals are received, is highest in the dependency hierarchy;
selecting a remedial action based on the identification of the error source module; and
outputting a remedial action notification including an indication of the error source module and/or the remedial action.

13. The method of claim 12, wherein the remedial action notification includes an indication of at least one error source computing device on which the error source module is executed.

14. The method of claim 12, further comprising programmatically executing the remedial action.

15. The method of claim 14, wherein programmatically executing the remedial action includes transferring execution of at least one module of the plurality of modules from a first set of one or more computing devices to a second set of one or more computing devices.

16. The method of claim 14, wherein programmatically executing the remedial action includes conveying a remedial action script for execution at the error source computing device.

17. The method of claim 12, further comprising storing a record of the identification of the error source module in non-volatile memory.

18. The method of claim 17, wherein the remedial action is selected based at least in part on one or more prior records of one or more respective identifications of prior error source modules.

19. The method of claim 12, further comprising:
training a machine learning algorithm using a plurality of training records of training remedial action identifications; and
selecting the remedial action using the machine learning algorithm.

20. A server computing device comprising:
non-volatile memory; and
a processor configured to execute instructions stored in the non-volatile memory to:
receive a plurality of telemetry signals from a plurality of modules executed on a plurality of computing devices in one or more data centers, wherein the plurality of modules are arranged in a dependency hierarchy;
determine that the plurality of telemetry signals include a plurality of error signals indicating errors at one or more of the modules;
based on the plurality of error signals and a representation of the dependency hierarchy stored in the non-volatile memory, identify an error source module that, among the plurality of modules from which error signals are received, is highest in the dependency hierarchy;
select a remedial action based on the identification of the error source module; and
programmatically execute the remedial action.
